(19) United States
(12) Patent Application Publication
(10) Pub. No.: US 2009/0180292 A1
(43) Pub. Date: Jul. 16, 2009

(54) ILLUMINANT DOORSILL DEVICE FOR AUTOMOBILE

(76) Inventor: CHANG-AN YANG, Hsi Chih City (TW)

Correspondence Address: LEONG C LEI, PMB # 1008, 1867 YGNACIO VALLEY ROAD, WALNUT CREEK, CA, 94598, US

(21) Appl. No.: 12/014,114

(22) Filed: Jan. 15, 2008

(51) Int. Cl. B60Q 1/26

(52) U.S. Cl. 362/488

(57) ABSTRACT

The illuminant doorsill device contains a plate member having a transparent element so that the light from a light source housed inside the plate member can emanate through. The light source is connected to an external battery box which contains one or more batteries through a power cable and a switch member. The power cable, switch member, and the battery box are laid along and positioned on the inside of a door frame, or hidden under a floor mat of the automobile.

### TECHNICAL FIELD OF THE INVENTION

The present invention generally relates to illuminant devices, and more particularly to an illuminant device installed along the doorsill of an automobile that will be turned on automatically when the automobile door is opened.

### DESCRIPTION OF THE PRIOR ART

As shown in FIG. 4, some recent models of automobiles have a plate 80 installed on the doorsill 83 of the automobile. The plate 80 is usually made of a metallic material and is usually engraved with anti-slipping textures and sometimes a logo of the model or the manufacturer of the automobile. To further enhance the appealing of the automobile, some light source is installed beneath the plate 80 and the light from the light source can emanate through some transparent element 82 when the door 81 is opened.

Quite a few such illuminant doorsill devices have been taught. For example, Republic of China Taiwan Patent Publication Nos. M255821 and 352684 are two related teachings disclosed by the present inventor.

For those automobiles originally without the illuminant doorsill devices, the replacement and installation of an illuminant doorsill device requires some degree of skill. As shown in FIG. 4, a power cable 41 from the light source has to be connected to the electrical system of the automobile for drawing electricity. Tampering with the automobile's original electrical system is not ordinary people's task and requires some caution so as not to damage the automobile's electrical circuits. This task may also void the warranty provided by the automobile manufacturer.

### SUMMARY OF THE INVENTION

As such, a novel illuminant doorsill device is provided, which is self-powered to avoid the tampering of the automobile's electrical system.

The illuminant doorsill device contains a plate member having a transparent element so that the light from a light source housed inside the plate member can emanate through. The light source is connected to an external battery box which contains one or more batteries through a power cable and a switch member. The power cable, switch member, and the battery box are laid along and positioned on the inside of a door frame, or hidden under a floor mat of the automobile.

The batteries are preferably re-chargeable ones and a battery charger can be provided to recharge the batteries. The battery charge can have a plug for plugging into a cigarette lighter socket of the automobile. In an alternative embodiment, instead of using batteries, the light source is directly connected to the cigarette lighter socket to draw electricity.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing the various components of an illuminant doorsill device according an embodiment of the present invention.

FIG. 2 is a schematic diagram showing the various components of an illuminant doorsill device according another embodiment of the present invention.

FIG. 3 is a schematic diagram showing the illuminant doorsill device of FIG. 1 installed on an automobile.

FIG. 4 is a schematic diagram showing a conventional illuminant doorsill device installed on an automobile.

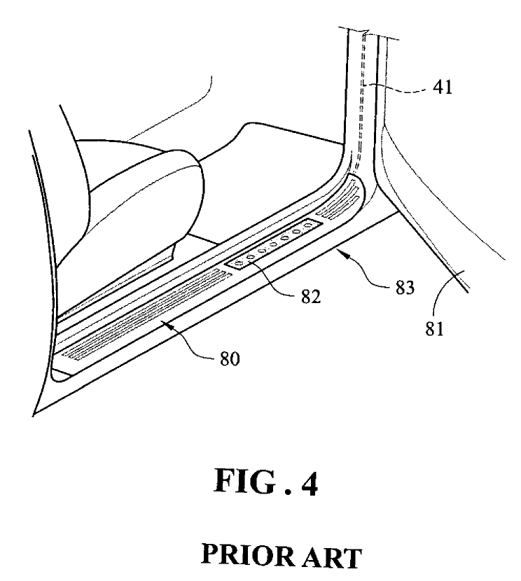

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

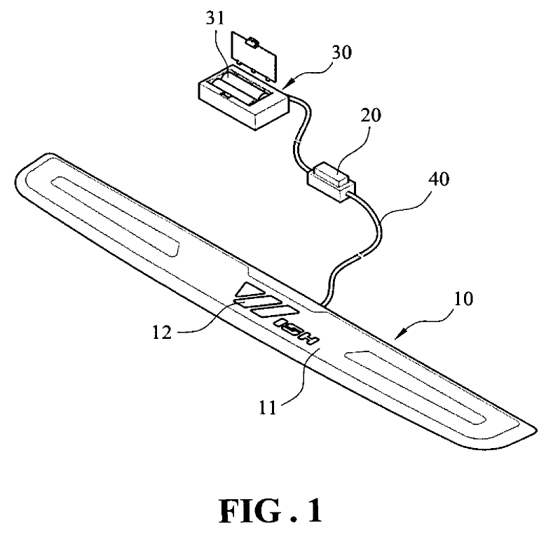

As shown in FIG. 1, an illuminant doorsill device 10 according to an embodiment of the present invention contains a plate member 11 having a logo or graphical image on a major surface. A transparent element 12 is embedded in the plate member 11 and exposed from the major surface. As such, the light from a light source (not shown) housed inside the plate member 11 can emanate through. The light source is connected to an external battery box 30 which contains one or more batteries 31 through a power cable 40. The conduction of electricity through the power cable 40 is controlled by a switch member 20 configured along the power cable 40. The batteries 31 contained in the battery box 30 are preferably re-chargeable one.

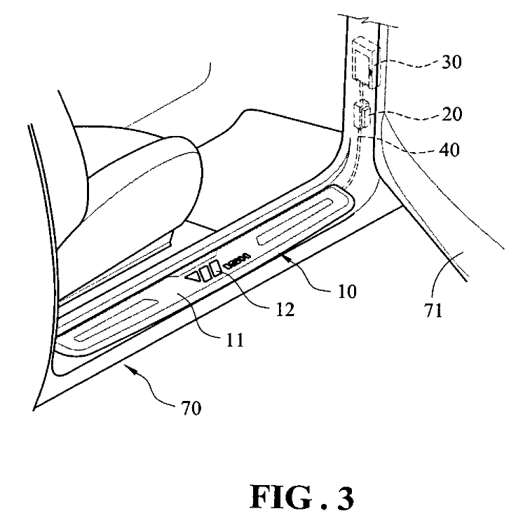

As shown in FIG. 3, the illuminant doorsill device 10 is installed on a doorsill 70 of an automobile. The power cable 40, switch member 20, and the battery box 30 are laid along and positioned on the inside of a door frame (not numbered). In an alternative embodiment, the power cable 40, switch member 20, and the battery box 30 can also be hidden under a floor mat of the automobile. The switch member 20 is a normally closed. That is, when the switch member 20 is not engaged the power cable 40 is conductive and the light source inside the plate member 11 is turned on. When the door is closed and an elastic button (not shown) of the switch member 20 is depressed by the door rim, the switch member 20 disrupts the conduction of the power cable 40 and thereby turns off the light source. When the door is opened, the elastic button is released and automatically returns to its normally closed position, and the light source of the plate member 11 is therefore turned on again.

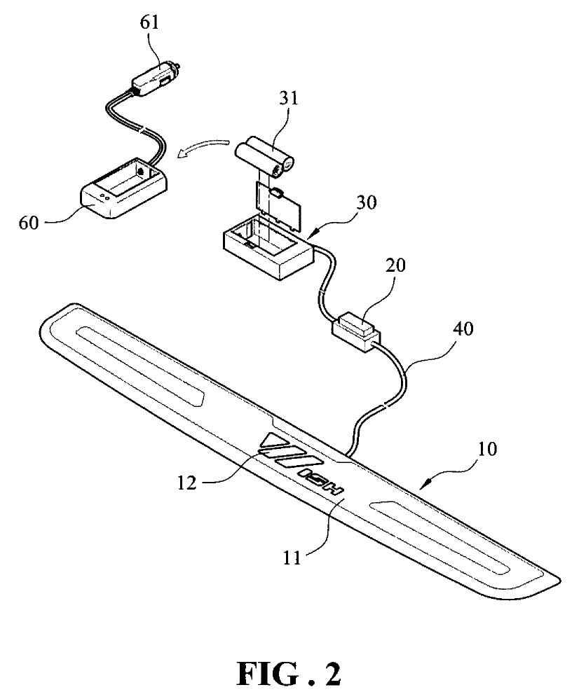

As mentioned earlier, the batteries 31 are preferably re-chargeable ones. Therefore, as shown in FIG. 2, a battery charger 60 can be provided to recharge the batteries 31 after they are removed from the battery box 30. The battery charger 60 can have a plug 61 for plugging into the cigarette lighter socket of the automobile.

As can be imagined, in an alternative embodiment, instead of using rechargeable batteries 31 and a battery box 30, the power cable 40 can be connected to the plug 61 directly so that the light source of the plate member 11 can directly draw its electricity from the battery of the automobile.

A major advantage of the present invention lies in the easy installation of the device without the need to tamper the automobile's electrical system and/or to dismantle major parts of the automobile. Another advantage is that the illuminant doorsill device is self-powered by rechargeable batteries which can be re-charged by a charger plugged into the cigarette lighter socket.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An illuminant doorsill device for an automobile, comprising:
a plate member installed on a doorsill of said automobile having an embedded transparent element exposed from a major surface and a light source housed inside said plate member;
a battery box having one or more batteries connected to said light source through a power cable; and
a normally closed switch member positioned along said power cable, said switch member disrupting the conduction of said power cable when an elastic button of said switch member is depressed by closing a door of said automobile and restoring the conduction when said elastic button is released by opening said door of said automobile.

2. The illuminant doorsill device according to claim 1, wherein said batteries are re-chargeable.

3. The illuminant doorsill device according to claim 1, wherein said power cable, said battery box, and said switch member are positioned either along the inside of a door frame of said door, or under a floor mat of said automobile.

4. An illuminant doorsill device for an automobile, comprising:
a plate member installed on a doorsill of said automobile having an embedded transparent element exposed from a major surface and a light source housed inside said plate member;
a power cable connected to said light source at one end and having a plug at the other end for plugging into a cigarette lighter socket of said automobile; and
a normally closed switch member positioned along said power cable, said switch member disrupting the conduction of said power cable when an elastic button of said switch member is depressed by closing a door of said automobile and restoring the conduction when said elastic button is released by opening said door of said automobile.
